(19) United States
(12) Patent Application Publication
(10) Pub. No.: US 2007/0271130 A1
(43) Pub. Date: Nov. 22, 2007

(54) Flexible scheduling and pricing of multicore computer chips

(75) Inventors: Behrooz Chitsaz, Bellevue, WA (US); Darko Kirovski, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/437,342

(22) Filed: May 19, 2006

(51) Int. Cl. G07G 1/00; G06F 9/46; G06F 17/30

(52) U.S. Cl. 705/10; 705/9

(57) ABSTRACT

Systems and methods are provided for flexible scheduling and pricing of multicore computer chips. Multicore computer chips can be scheduled to operate correctly despite nonoperational components by adjusting scheduling. They may be sold at a price that accounts for an extent to which components are not operational, because additional operational components allow for higher performance.

### BACKGROUND

Moore's Law says that the number of transistors we can fit on a silicon wafer doubles every year or so. No exponential lasts forever, but we can reasonably expect that this trend will continue to hold over the next decade. Moore's Law means that future computers will be much more powerful, much less expensive, there will be many more of them and they will be interconnected.

Moore's Law is continuing, as can be appreciated with reference to FIG. 1, which provides trends in transistor counts in processors capable of executing the x86 instruction set. However, another trend is about to end. Many people know only a simplified version of Moore's Law: “Processors get twice as fast (measured in clock rate) every year or two.” This simplified version has been true for the last twenty years but it is about to stop. Adding more transistors to a single-threaded processor no longer produces a faster processor. Increasing system performance must now come from multiple processor cores on a single chip. In the past, existing sequential programs ran faster on new computers because the sequential performance scaled, but that will no longer be true.

Future systems will look increasingly unlike current systems. We won't have faster and faster processors in the future, just more and more. This hardware revolution is already starting, with 2-8 core computer chip design appearing commercially. Most embedded processors already use multi-core designs. Desktop and server processors have lagged behind, due in part to the difficulty of general-purpose concurrent programming.

It is likely that in the not too distant future chip manufacturers will ship massively parallel, homogenous, many-core architecture computer chips. These will appear, for example, in traditional PCs and entertainment PCs, and cheap supercomputers. Each processor die may hold fives, tens, or even hundreds of processor cores.

As a practical matter, some number of random defects are inevitable in electrical component manufacturing and assembly. In a multicore chip with a large number of components, the likelihood of one or more defective components somewhere on the chip is increased. It is therefore desirable to address the inevitable problem of defective components without allowing the cost of manufacture to become excessive, as may occur if all multicore chips found to contain defective components were discarded.

### SUMMARY

In consideration of the above-identified shortcomings of the art, the present invention provides systems and methods for flexible scheduling and pricing of multicore computer chips. In one exemplary embodiment, an operational status of a plurality of components of a computer chip can be determined, and the chip and/or software to execute on the chip or other aspects of a system comprising the chip can be configured to operate correctly without the use of any nonoperational components. For example, chips can operate correctly despite nonoperational components by adjusting scheduling. Computer chips may be sold at a price that accounts for an extent to which components are not operational. Chips with many operational components can fetch a higher price that chips with fewer operational components, because while both would operate correctly, additional operational components will allow for higher performance. Other advantages and features of the invention are described below.

### BRIEF DESCRIPTION OF THE DRAWINGS

The systems and methods for flexible scheduling and pricing of multicore computer chips in accordance with the present invention are further described with reference to the accompanying drawings in which:

FIG. 1 illustrates trends in transistor counts in processors capable of executing the x86 instruction set.

FIG. 2 illustrates a multicore computer chip that comprises a variety of exemplary components such as several general purpose controller, graphics, and digital signal processing computation powerhouses.

FIG. 3 illustrates a system comprising a computer chip 350 with a plurality of functional groups.

FIG. 4 illustrates a method comprising determining operational status of chip components, configuring a system comprising the chip, and selling the chip at a price that accounts for any nonoperational components.

FIG. 5 illustrates a contemplated embodiment in which components of a multicore chip are disabled so the chip can be sold at a reduced price.

FIG. 6 illustrates an exemplary signal that may be sent to chip components, and the response signals that may be received in return indicating which components are and are not operational.

FIG. 7 illustrates an exemplary method in which an operating system discovers chip topology and configures itself to interact with the chip so as not to utilize nonoperational components.

FIG. 8 illustrates an exemplary method for renting available components on a multicore chip to third parties.

FIG. 9 illustrates an exemplary method in which a manufacturer tests chips and associates configuration data with chip identifiers which may be subsequently used to configure systems comprising the tested chip.

FIG. 10 illustrates an exemplary computing device in which the various systems and methods contemplated herein may be deployed.

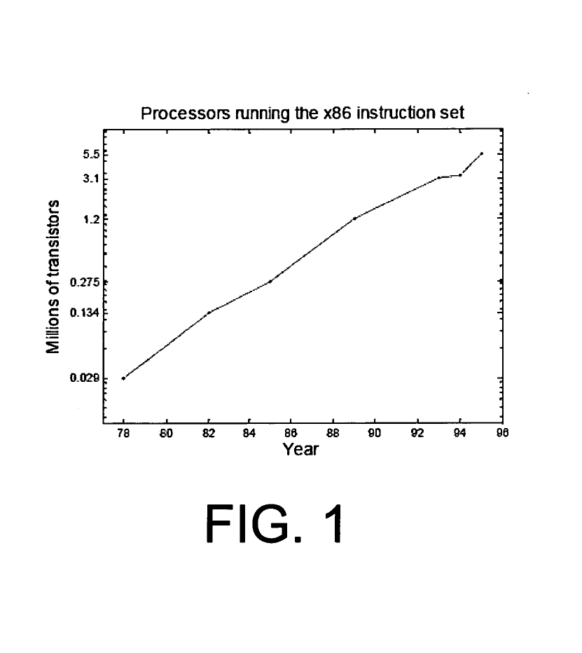

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Due to the increase of on-chip latency in super-linear manner with respect to interconnect length, multicore computer chips are increasingly built as a network of functional groups connected via a networking structure that comprises buses, routers, and relays. This type of architecture allows for maximum increase of localized clock frequencies and thus, improved system throughput.

Processes such as firewalls, malware scanners, device drivers, and peer-to-peer networking handlers can be executed on separate processors with dedicated or shared memory and with optimized datapaths. For example, a 100-million transistor processor can pack 3450 i8086 or 18 Pentium P6 processors; obviously a substantial computational power at high frequency clocks that is hard to equal by context switching a large number of processes and/or exploring better instruction level parallelism of individual threads using extreme pipelining or superscalar units but at low frequency clocks.

As systems are integrated using many functional groups, they can be configured to tolerate certain low rates of manufacturing defects and as a result enable increasing die sizes. As long as the networking hardware enables a minimum required level of connectivity among malfunction-free cores, the multicore computer chip may remain marketable. Thus, a small subset of the originally planned hardware may be disabled due to corruption during manufacturing. Of course, this subset is unknown before manufacturing and may be distinct per chip.

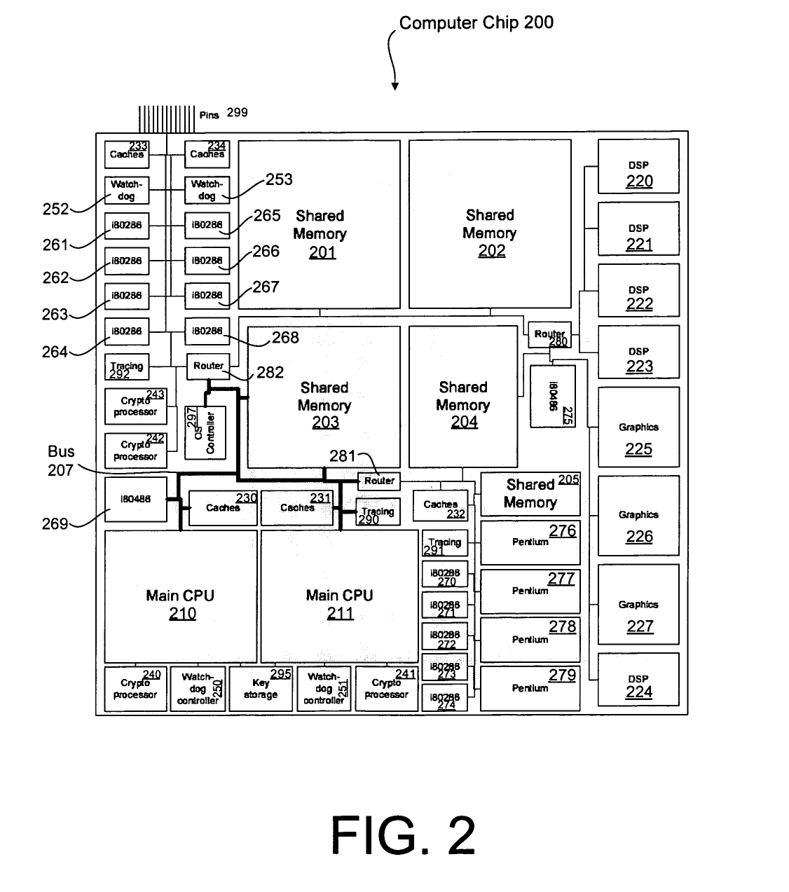

FIG. 2 gives an example of a computer chip that comprises a variety of components including several general purpose controller, graphics, and digital signal processing computation powerhouses. This allows for maximum increase of localized clock frequencies and improved system throughput. As a consequence, system's processes are distributed over the available processors to minimize context switching overhead.

It will be appreciated that a multicore computer chip 200 such as that of FIG. 2 can comprise a plurality of components including but not limited to processors, memories, caches, buses, and so forth. For example, chip 200 is illustrated with shared memory 201-205, exemplary bus 207, main CPUs 210-211, a plurality of Digital Signal Processors (DSP) 220-224, Graphics Processing Units (GPU) 225-227, caches 230-234, crypto processors 240-243, watchdog processors 250-253, additional processors 261-279, routers 280-282, tracing processors 290-292, key storage 295, Operating System (OS) controller 297, and pins 299.

Components of chip 200 may be grouped into functional groups. For example, router 282, shared memory 203, a scheduler running on processor 269, cache 230, main CPU 210, crypto processor 240, watchdog processor 250, and key storage 295 may be components of a first functional group.

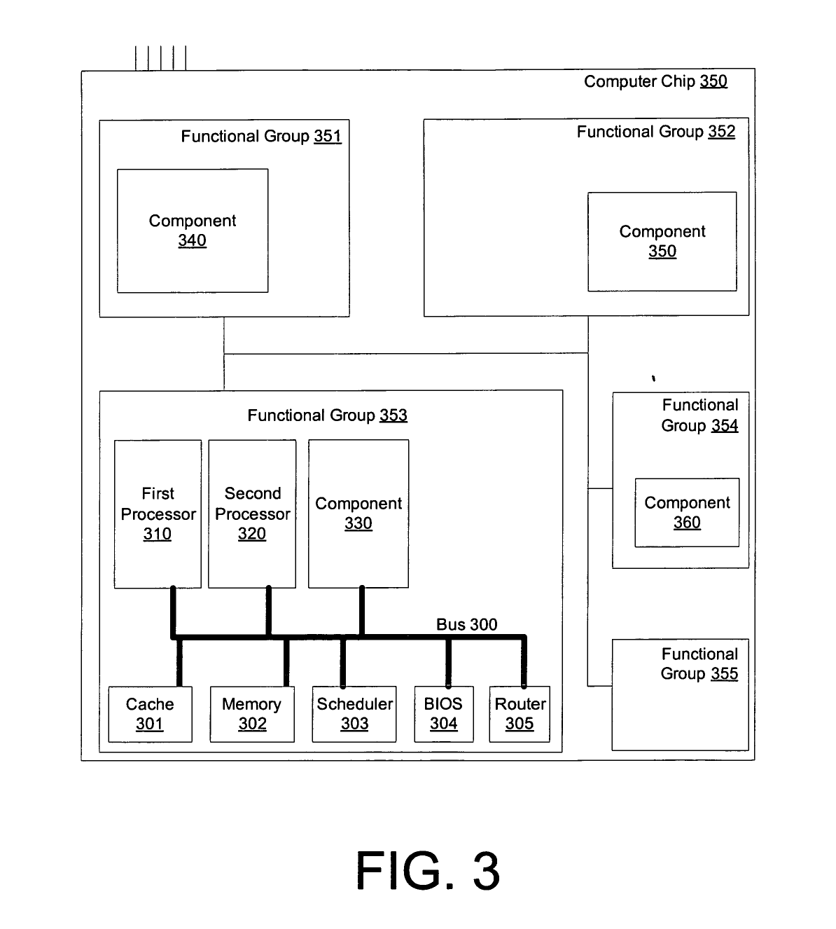

FIG. 3. illustrates a multicore chip 350 with components such as first processor 310, second processor 320, third processor 330, component 340, component 350, and component 360. A component, as that term is used herein, is an aspect of chip hardware that performs some discrete function. As such, the various functional groups 351-353 and also bus 300, cache 301, memory 302, scheduler 303, Basic Input/Output System (BIOS) 304, and router 305 may also be considered components. A component is said to be operational when it functions as it is intended to function. Conversely, a component is nonoperational when it does not function as intended.

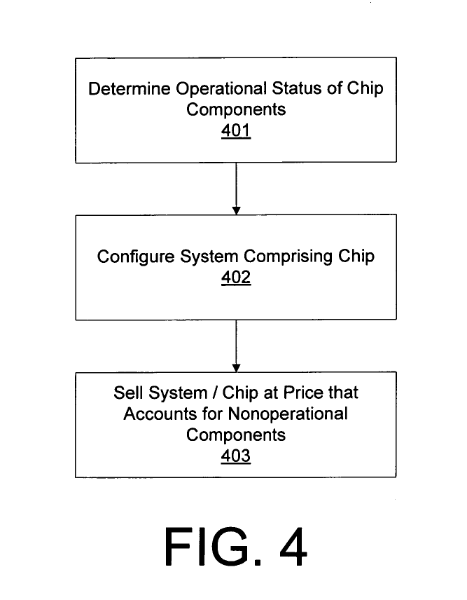

FIG. 4 illustrates an exemplary method for distributing a computer chip which may be performed in one embodiment of the contemplated invention. First, an operational status of a plurality of components of a computer chip may be determined 401. For example, referring back to FIG. 3, it may be determined that various of the illustrated components are operational while various other illustrated components are nonoperational. Such determining may be accomplished by any number of approaches. In one embodiment, an operating system may be configured to discover the operational status of chip 350 components. Alternatively, operational status may be discovered during testing by a chip manufacturer or distributor, or by a third party quality control, or specialized software for determining operational status, and the like.

A system comprising the chip may next be configured in step 402 such that the system as a whole is operational despite the at least one component that is nonoperational. An exemplary system that may be configured is, for example, a computing device such as the device generally discussed and described below. A computing device may comprise both hardware and software, either or both of which may be configured to accommodate nonoperational components of a chip. In one embodiment, software such as an operating system or a Just-In-Time compiler (JITer) may be configured to schedule tasks in a manner that avoids use of any nonoperational components. In other embodiments, such functionality may be embodied in hardware, or the chip itself may be physically modified to avoid use of the nonoperational components. In this regard, the chip itself should be considered to be a system comprising the chip, as well as any systems that add further software, hardware, and so forth to build a system comprising additional functionality beyond the chip itself.

A next step 403 can comprise selling the chip and/or a system comprising the chip at a price that accounts for any nonoperational components in the chip. This step may be performed instead of or in addition to step 402. The chip price may be set according to any number of factors that are more or less related to the number of operational components. In one embodiment, a price may be set for a plurality of components on the chip, and the ultimate cost of the chip is based on adding the prices of all components that are deemed operational. In another embodiment, chip price may be set based on a level of chip performance that can be obtained despite the nonoperational components. In another embodiment, chip price may be based on the percentage of operational (or, conversely, nonoperational) components in the chip.

Other embodiments are of course also possible, such as methods wherein a system comprising the chip is sold at full price and a refund is made available if and when defective aspects of the chip are discovered. The party that does the selling may be, for example, the chip manufacturer, an assembler who builds a system comprising the chip, and a retail store such as an online or physical location where end-user systems may be purchased.

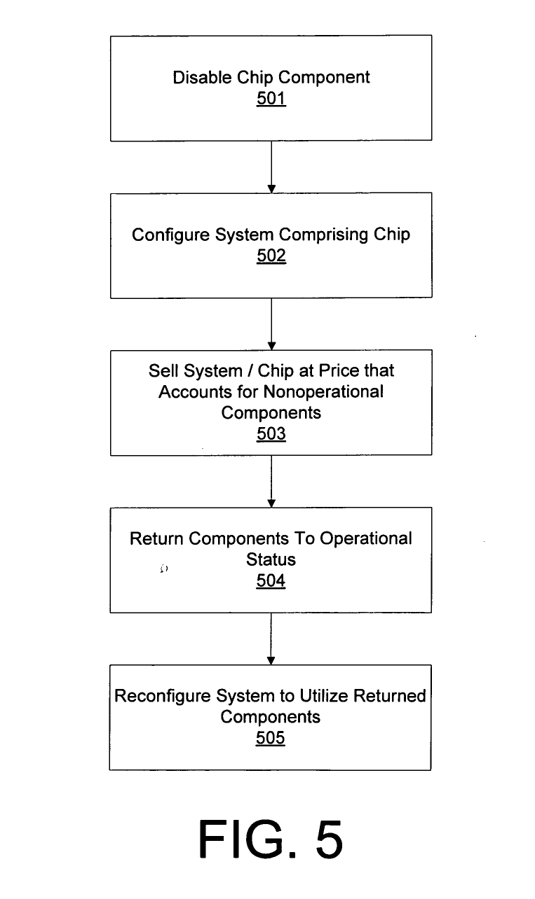

FIG. 5 illustrates a further embodiment which expands upon the possibilities presented in FIG. 4 to allow the possibility of disabling chip components in order to price computer chips at multiple levels. Much of the cost involved in chip manufacture is a front-end cost of developing chip design and building the equipment that will fabricate the chip in volume. Manufacturers can exploit economies of scale by building very powerful full featured computer chips according to a single chip design. However, many customers may not want to pay for the very powerful chip. The manufacturer, or other party may disable some components of the chip 501, configure it to operate despite the disabled components 502, and sell the chip at a reduced price 503. Here, the manufacturer may render some components of a chip nonoperational (at least temporarily so) because it is cheaper than building a separate, lower-end chip to serve lower-end markets.

If a component is only temporarily disabled, a customer may be given the option to pay for extra components at a time subsequent to purchase, at which time one or more of the disabled components may be returned to operational status 504. Any system comprising the chip may be reconfigured 505 to make use of additional available chip components.

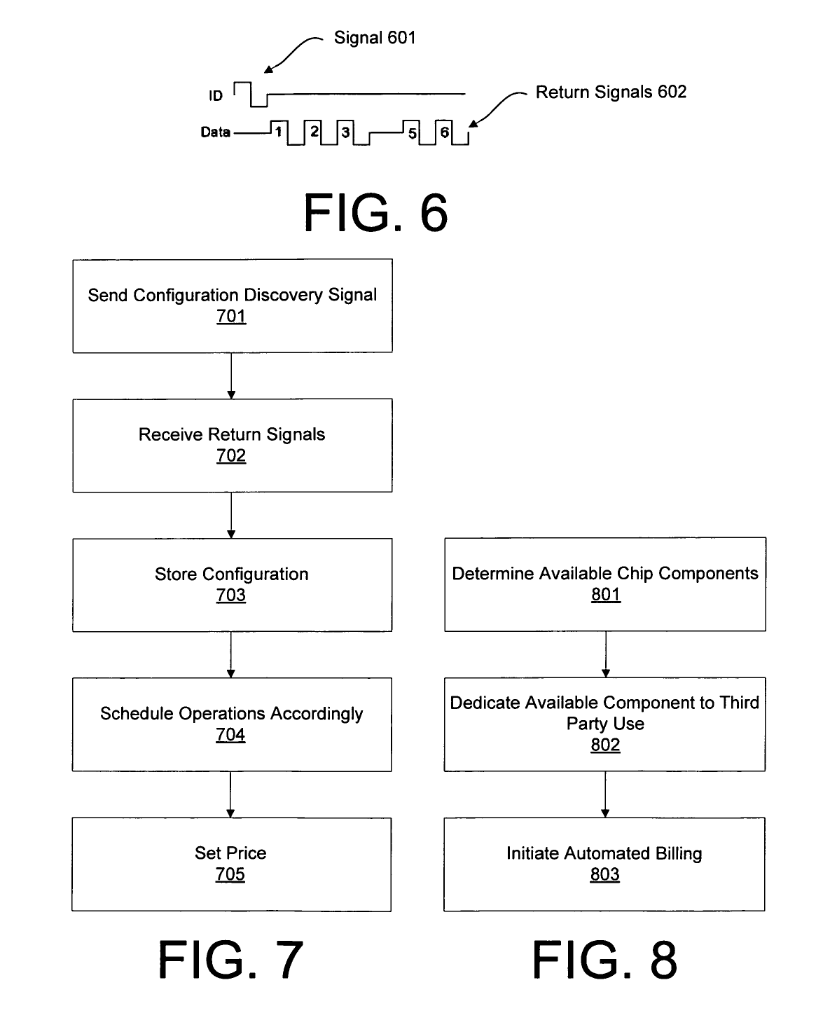

FIGS. 6 and 7 illustrate an exemplary embodiment and further aspects of the invention in which software such as an operating system may generally perform the steps of the method set forth in FIG. 4, as well as additional operations as will be understood. With reference to FIGS. 6 and 7, one or more components may announce to the operating system a configuration of multicore computer chip hardware, thereby providing information regarding which components are and are not operational. The illustrated processes can occur, for example during a boot up of an operating system. In one embodiment, an operating system may discover chip topology on a first boot, and may subsequently configure itself to interoperate with existing chip topology, for example by storing appropriate configuration information and subsequently using such information to schedule operations on the chip.

In FIG. 6, a computer program such as an operating system may send a signal 601 calling for announcements across a data bus. In response to signal 601, chip components may send return signals 602. The computer program can read return signals 602, and thereby determine which components are operational. As can be appreciated with reference to FIG. 6, some or all chip components may be assigned unique sequential identifiers, e.g., 0 to N−1. FIG. 6 contemplates six components with six sequential identifiers, numbered 1 through 6. Components announce their existence on an adjoining bus segment via return signals 602 in consequent clock cycles on the data bus. Absence of expected data at cycle K indicates that the K-th component is nonoperational. In the illustrated example, component 4 is nonoperational.

Further to this exemplary embodiment, a procedure such as that described with reference to FIG. 6 can be performed on each functional group, e.g., 351-355. Once they learn the local topology of the functional groups, routers may forward lists of operational and/or nonoperational components toward a processor running an operating system boot procedure, e.g. first processor 310. Upon receiving messages from all routers, the operating system can conclude the resulting chip topology, and use this information to schedule operations. Information pertaining to chip topology can be stored in a BIOS 304 or an external non-volatile memory 302. It can be reused after each system reboot without having to repeat the announcement procedure of FIG. 6. This procedure assumes that all routers and bus segments are free of corruptions, and can be modified in settings in which routers and bus segment components must also be checked for defects, as described below.

In large systems, it may make sense to allow for corruption of router components as well. In the context of the above described embodiment, potential router defects can be accounted for by, for example, learning a connectivity network by an operating system. Referring back to FIG. 3, consider an embodiment in which the first processor 310 runs the operating system boot routine. In this case, the operating system may initiate from the router/routers 305 that control the bus segment 300 to which 301 is attached, a call for discovering the chip's 350 bus network. Each router in the various functional groups 351-355, upon receiving the call sends back its absentee list as well as a list of neighboring routers. Then, it appends its ID to a list of already visited routers and asks the neighboring routers to perform the same procedure. A router does not perform this procedure if it is in the list of already visited routers. Once the operating system learns the chip 350 topology it can save it in external non-volatile memory 302 or 304 and reuse the result in future reboots.

FIG. 7 illustrates exemplary steps to be performed by an operating system in order to implement this embodiment of the invention. First, the operating system may send a topology discover signal, such as 601. Next, it can receive return signals 602 indicating which components are operational. The operating system may also perform some management during the receiving of return signals, for example by compiling lists, performing security and other functions, reducing redundant component queries and so forth. Once chip topology is understood, it may be stored 703, for example in a BIOS. The operating system may now and during subsequent sessions schedule operations 704 such that nonoperational components and/or nonoperational functional groups are not utilized.

A price can be set for a system comprising the chip 705. For example, the first boot of the operating system may be performed in-store or in-factory. In the case of a desktop or laptop computer, for example, the computer may be first booted in the factory or at the place of assembly, and the extent of chip corruption may be accordingly discovered by technicians or by an automated process for such purpose. The computer may then be priced based on such information. Alternatively, as mentioned above, the operating system may automatically apply for an appropriate refund based on the capabilities of the chip as discovered. It should further be noted that price can depend on a wide variety of factors. A computer program may go so far as to set a price for a chip or system comprising the chip, or may stop at outputting a value that corresponds to chip value, and therefore chip price. Such values may subsequently be used in a wide variety of ways to set a finial price for systems comprising the chip.

FIG. 8 illustrates a further embodiment of the invention in which systems and methods that may be utilized for discovery of component operational status may further be used in a network environment to rent operational chip components. Available operational chip components may be determined 801, and if acceptable to the owner of the chip, may be dedicated to third party use 802. For example, it is not uncommon in a university for a professor to need large amounts of computing power to conduct a particular experiment. The needed power may go far beyond the capabilities of his own lab. Such a situation may be addressed if the professor can rent processing power on other's devices. Because a chip can be configured to operate without the use of certain components as described herein, renting chip components to third parties is facilitated and will not prevent the owner of the rented component from using their own system, although it may degrade performance. In one exemplary embodiment, an operating system can comprise instructions for allowing a third party to use at least one operational component of a computer chip, and instructions for billing the third party.

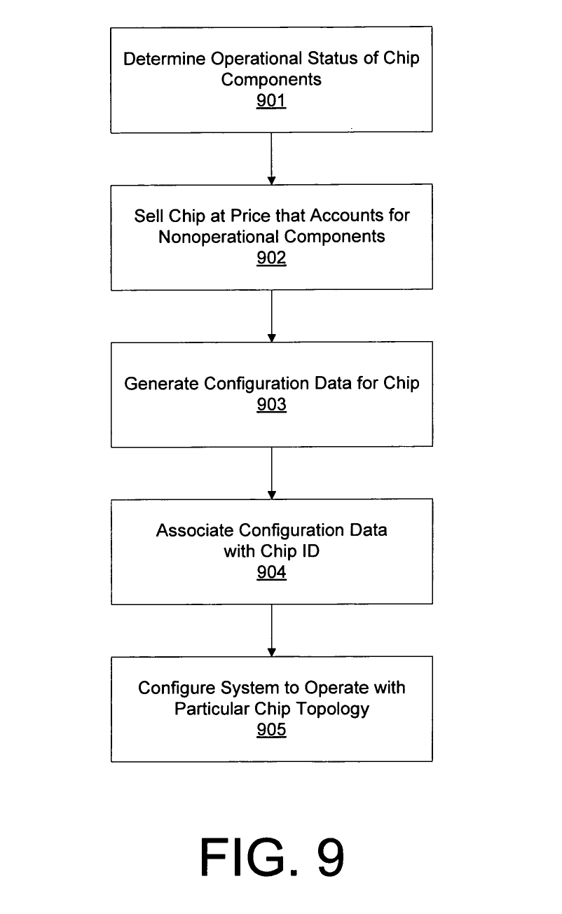

It should be emphasized that discovery of chip topology by an operating system is merely one embodiment of many possible embodiments. Another exemplary embodiment is illustrated in FIG. 9. A scenario contemplated by FIG. 9 is one in which testing of a multicore computer chip may be performed by testing equipment at the manufacturer, as most of today's computer chips are tested. Instead of discarding chips that display some defects, it can be determined whether the chip as a whole is still operational. If it is, operational status of chip components may be determined 901, and the chip may be sold at an appropriately reduced price 902. In such embodiments, chip topology information can be output to a database comprising computer chip identifiers and corresponding chip configuration data 903. The chip configuration data may be associated with a chip identifier 904. The chip configuration data may thus be subsequently utilized to configure any technologies, such as operating systems, other electronics, JITers, and the like that may interface with the chip 905. Here, the chip configuration data may be utilized by an assembler of a system comprising the chip, and may be obtained for example from a configuration disk that is distributed with the chip, or via a manufacturer database connection, or even over a computer network such as the internet.

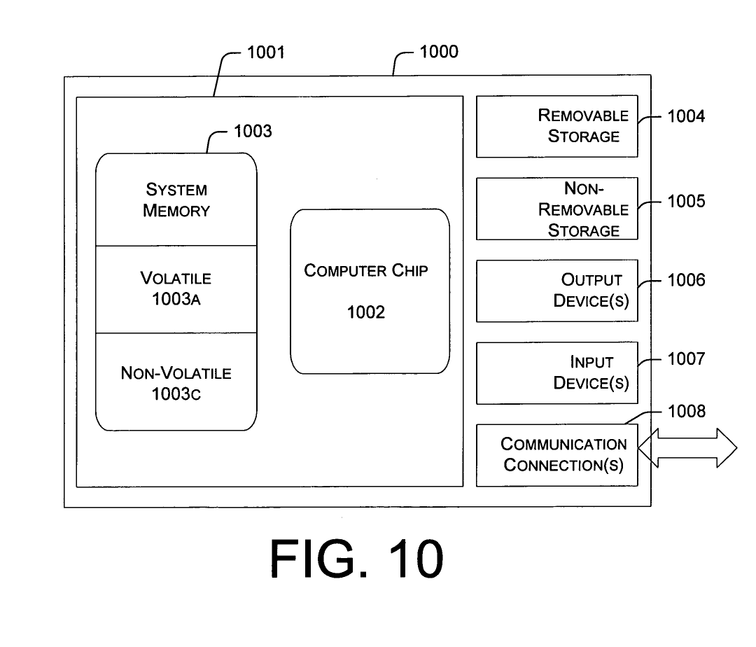

FIG. 10 illustrates an exemplary computing device 1000 in which the various systems and methods contemplated herein may be deployed. An exemplary computing device 1000 suitable for use in connection with the systems and methods of the invention is broadly described. In its most basic configuration, device 1000 typically includes a processing unit 1002 and memory 1003. Depending on the exact configuration and type of computing device, memory 1003 may be volatile (such as RAM), non-volatile (such as ROM, flash memory, etc.) or some combination of the two. Additionally, device 1000 may also have mass storage (removable 1004 and/or non-removable 1005) such as magnetic or optical disks or tape. Similarly, device 1000 may also have input devices 1007 such as a keyboard and mouse, and/or output devices 1006 such as a display that presents a GUI as a graphical aid accessing the functions of the computing device 1000. Other aspects of device 1000 may include communication connections 1008 to other devices, computers, networks, servers, etc. using either wired or wireless media. All these devices are well known in the art and need not be discussed at length here.

The invention is operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, cell phones, Personal Digital Assistants (PDA), distributed computing environments that include any of the above systems or devices, and the like.

In light of the diverse computing environments that may be built according to the general frameworks provided in the Figures, the systems and methods provided herein cannot be construed as limited in any way to a particular computing architecture. Instead, the present invention should not be limited to any single embodiment, but rather should be construed in breadth and scope in accordance with the appended claims.

1. A method for distributing a computer chip, comprising:
determining an operational status of a plurality of components of a computer chip;
selling said computer chip at a price that is reduced to account for at least one component of said computer chip that is not operational.

2. The method of claim 1, further comprising configuring a system comprising said computer chip such that said system as a whole is operational despite the at least one component of said computer chip that is not operational.

3. The method of claim 2, wherein said configuring a system comprises configuring a Basic Input/Output System (BIOS).

4. The method of claim 1, further comprising generating configuration data for said computer chip, wherein said configuration data identifies an operational status of at least one component of said computer chip.

5. The method of claim 4, further comprising associating said configuration data with an identifier for said computer chip.

6. The method of claim 1, wherein said at least one component comprises a processor.

7. The method of claim 1, wherein said determining an operational status of a plurality of components of a computer chip comprises announcing, by at least one processor, an existence of said at least one processor.

8. A computer program comprising computer-executable instructions, said instructions comprising:
instructions for determining an operational status of a plurality of components of a computer chip;
instructions for generating a value that corresponds to a price for said computer chip, wherein said price accounts for at least one component of said computer chip that is not operational.

9. The computer program of claim 8, wherein said computer program further comprises instructions for configuring a system comprising said computer chip such that said system as a whole is operational despite the at least one component of said computer chip that is not operational.

10. The computer program of claim 9, wherein said instructions for configuring a system comprise instructions for configuring a Basic Input/Output System (BIOS).

11. The computer program of claim 8, wherein said computer program further comprises instructions for allowing a third party to use at least one operational component of said computer chip.

12. The computer program of claim 11, wherein said computer program further comprises instructions for billing said third party.

13. The computer program of claim 8, wherein said instructions for determining comprise instructions for receiving a signal from at least one processor on said chip.

14. The computer program of claim 8, wherein said at least one component comprises a processor.

15. A method for scheduling operations on a computer chip, said method comprising:
determining an operational status of a plurality of components of a computer chip;
scheduling operations such that at least one operational component of said computer chip contributes to said operations, while at least one non-operational component of said computer chip does not contribute to said operations.

16. The method of claim 15, wherein said method is utilized by a Just-In-Time compiler (JITer).

17. The method of claim 15, wherein said method utilizes operational status data stored in a Basic Input/Output System (BIOS).

18. The method of claim 15, further comprising announcing, during a boot of said computer chip, said operational status of a plurality of components.

19. The method of claim 15, further comprising allowing a third party to use at least one operational component of said computer chip.

20. The method of claim 19, further comprising billing said third party.
